(19) United States
(12) Patent Application Publication
(10) Pub. No.: US 2025/0069101 A1
(43) Pub. Date: Feb. 27, 2025

(54) SYSTEM AND METHOD FOR GENERATING PERSONALIZED INSIGHTS OF FINANCIAL INSTRUMENTS BASED ON AI ASSISTED ANALYSIS

(71) Applicant: Royal Bank of Canada, Toronto (CA)

(72) Inventors: Anusha SHEKHAR, Toronto (CA); Gabriel MOK, Toronto (CA); Chloe KOELMEL, Toronto (CA); Liam MACLEAN, Toronto (CA)

(21) Appl. No.: 18/811,215

(22) Filed: Aug. 21, 2024

Related U.S. Application Data
(60) Provisional application No. 63/533,994, filed on Aug. 22, 2023.

(51) Int. Cl. G06Q 30/0202; G06Q 40/06

(52) U.S. Cl. CPC G06Q 30/0202; G06Q 40/06

(57) ABSTRACT

A method for generating a personalized analysis for a user of network based content obtained from a plurality of network sources using a user profile of the user in conjunction with a large language model (LLM), the network sources available over a communications network, the method comprising the steps of: assembling the user profile to contain user profile data including financial instrument information and user interest data associated with the user, the financial information pertaining to a set of financial instruments; storing the user profile data in a storage for use as a set of content search parameters and storing user interest data in the storage for use as a set of content filters; comparing the content search parameters to the network based content obtained from a set of network sources to determine matching content, the set of network sources selected from the plurality of network sources; providing the matching content and one or more content filters from the set of content filters to an LLM in order to derive a chain of thought based output relevant to the matching content and the one or more content filters; requesting the LLM to determine one or more insights using the chain of thought based output in order to generate the personalized analysis; and generating an insight notification to include the personalized analysis including the one or more insights; and sending the insight notification over the communications network to the user for subsequent processing.

### TECHNICAL FIELD

The present disclosure is directed at methods, systems, and techniques for using AI assisted analysis.

### BACKGROUND

A very real problem in the financial services industry is excessive time and investment required to sort through all information sources relevant to one or more traded financial instruments such as stocks and bonds. Currently, sales-traders need to spend excessive amounts of time to react to the release/occurrence of news articles, market events, and research reports associated with their clients and client portfolios. Further, time can be of the essence in market trading and thus excessive time spent finding, reading and analyzing numerous available pieces of information can detrimentally detract from the timely understanding of sales-trades on the potential impact of news articles, market events and research reports on their daily trading activities. Further, the clients of the sales-traders continually demand financial expertise and advice in a timely manner in order to consider the sale-trader as an informed and efficient provider of financial services (e.g. financial portfolio management).

### SUMMARY

An object of the present invention is to provide a system and/or method of network service accessibility monitoring to obviate or mitigate at least one of the above-presented disadvantages of the state of the art.

According to a first aspect, there is provided a method for generating a personalized analysis for a user of network based content obtained from a plurality of network sources using a user profile of the user in conjunction with a large language model (LLM), the network sources available over a communications network, the method comprising the steps of: assembling the user profile to contain user profile data including financial instrument information and user interest data associated with the user, the financial information pertaining to a set of financial instruments; storing the user profile data in a storage for use as a set of content search parameters and storing user interest data in the storage for use as a set of content filters; comparing the content search parameters to the network based content obtained from a set of network sources to determine matching content, the set of network sources selected from the plurality of network sources; providing the matching content and one or more content filters from the set of content filters to an LLM in order to derive a chain of thought based output relevant to the matching content and the one or more content filters; requesting the LLM to determine one or more insights using the chain of thought based output in order to generate the personalized analysis; and generating an insight notification to include the personalized analysis including the one or more insights; and sending the insight notification over the communications network to the user for subsequent processing.

A further aspect provided is a computer system for generating a personalized analysis for a user of network based content obtained from a plurality of network sources using a user profile of the user in conjunction with a large language model (LLM), the network sources available over a communications network, the system comprising: a set of instructions stored on a computer readable medium for causing one or more computer processors to: assemble the user profile to contain user profile data including financial instrument information and user interest data associated with the user, the financial information pertaining to a set of financial instruments; store the user profile data in a storage for use as a set of content search parameters and storing user interest data in the storage for use as a set of content filters; compare the content search parameters to the network based content obtained from a set of network sources to determine matching content, the set of network sources selected from the plurality of network sources; provide the matching content and one or more content filters from the set of content filters to an LLM in order to derive a chain of thought based output relevant to the matching content and the one or more content filters; request the LLM to determine one or more insights using the chain of thought based output in order to generate the personalized analysis; and generating an insight notification to include the personalized analysis including the one or more insights; and send the insight notification over the communications network to the user for subsequent processing.

A further aspect provided is a computer readable media having stored instructions thereon for execution by a computer processor for generating a personalized analysis for a user of network based content obtained from a plurality of network sources using a user profile of the user in conjunction with a large language model (LLM), the network sources available over a communications network, the computer processor executing the stored instructions to: assemble the user profile to contain user profile data including financial instrument information and user interest data associated with the user, the financial information pertaining to a set of financial instruments; store the user profile data in a storage for use as a set of content search parameters and storing user interest data in the storage for use as a set of content filters; compare the content search parameters to the network based content obtained from a set of network sources to determine matching content, the set of network sources selected from the plurality of network sources; provide the matching content and one or more content filters from the set of content filters to an LLM in order to derive a chain of thought based output relevant to the matching content and the one or more content filters; request the LLM to determine one or more insights using the chain of thought based output in order to generate the personalized analysis; and generating an insight notification to include the personalized analysis including the one or more insights; and send the insight notification over the communications network to the user for subsequent processing.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows an example system diagram of a system including a content analysis service based on user profile data;

FIG. 2 shows a block diagram of the example computing device of the system of FIG. 1;

FIGS. 3, 4 show an example configuration of the service of FIG. 1;

FIG. 5 shows an overview of an example embodiment of the system of FIGS. 3,4;

FIGS. 6,7 show an example user workflow of the service of the content analysis service of FIG. 1; and

FIGS. 8 to 13 provide an alternative embodiment of the system of FIG. 1.

### DETAILED DESCRIPTION

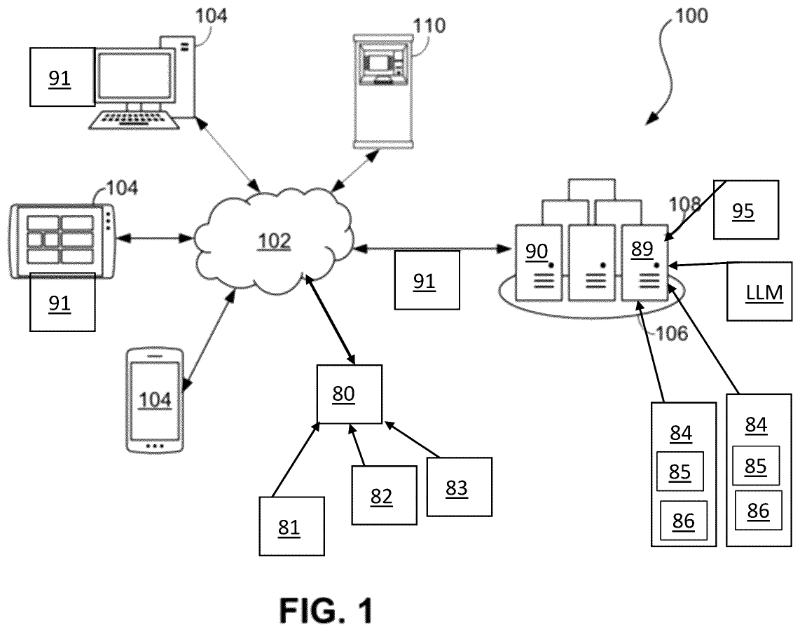

Referring now to FIG. 1, there is shown a computer network system 100 that comprises an example embodiment of a content analysis service 89 for generating insight notifications (e.g. personalized analysis 91) using generative AI (e.g. LLM) to provide client facing sales-traders (e.g. users/members of a financial institution) with personalized and real-time analysis of the impact of available network based content 80, such as but not limited to news articles 81, market events 82, and/or research reports 83 (e.g. internal research of a financial institution of which the sales-trader is a member/employee), on the trading activity of the sales-traders.

Advantages of operation of the computer network system 100 include: reducing the amount of time sales-traders need to spend to react to the release/occurrence of news articles 81, market events 82, and/or research reports 83 (hereafter generally referred to as network based content 80) associated with their clients and client portfolios; facilitate sales-trades to timely understand the potential impact of the network based content 80 on their daily trading activities; and facilitate the sales-traders to provide their clients with desired financial expertise and advice in a timely manner in order to portray the sale-trader as an informed and efficient provider of financial services (e.g. financial portfolio management via the trading services 90), in particular to client of the financial institution.

Referring again to FIG. 1, there is shown a computer network system 100 shown is a wide area network 102 such as the Internet to which various user devices 104 (for example a mobile device), an ATM 110, and data center 106 are communicatively coupled. The data center 106 comprises a number of servers 108 networked together to collectively perform various computing functions. For example, in the context of a financial institution such as a bank (one example of an institution), the data center 106 may host (e.g. online) trading services 90 that facilitate users (e.g. sales-traders) to log in to those servers 108 using user accounts that give them access to the various computer-implemented financial instrument services 90 such as stock trading platforms, bond trading platforms, general investment platforms, etc, such as implementation of real-time trades. For example, the trading service 90 can be accessed via the network 102 using a client-server model, e.g. an application 91 executed on the user device 104 that communicates with the network trading service 90 hosted on one or more of the servers 108.

Also provided is a network content analysis service 89, which can be used by users of the system 100 in order to receive the personalized analysis 91, as further described below. It is recognized that the content analysis service 89 and the trading service 90 can be referred to as network services. In general, a network service 89, 90 can be refer to a software application provided in computer networking (e.g. via the network 102). Network services 89, 90 are applications at the network 102 application layer that connect users working in offices, branches, or remote locations to applications and data (e.g. network based content 80) available in the network 102. These services 89, 90 run on the servers 108. A network 102 is an interconnection of computers 104,108 that share resources. The network 102 can be made up of interconnected client 104 and server 108 computers. The network services 90 can be thought of as operands in the network 102 provided by server(s) 108 requested by the client computers 104.

Therefore, a network service 89, 90 as one embodiment is an application running at a network application layer (of the network 102) and above, such that the network service 90 provides data storage, manipulation, presentation, communication or other capabilities which can be implemented using a client-server or peer-to-peer architecture based on application layer network protocols (e.g. communication between client devices 104 and one or more servers 108 hosting the network service 90). Each network service 89, 90 can be provided by a server component running on one or more computers 108 (often a dedicated server computer 108 offering multiple services 89, 90) and accessed via a network 102 by client components running on other devices 104. However, the client and server components can both be run on the same machine, if desired. Clients 104 and servers 108 can have a user interface (e.g. GUI), and sometimes other hardware associated with the device 104,108 shared or otherwise dedicated to the service 89, 90 and the network 102 interaction therewith.

In particular, the user profile 84 of each user is made available or otherwise generated by the content analysis service 89 to include user profile data including financial instrument information 85 and user interest data 86 associated with each user, the financial information 85 pertaining to a set of financial instruments such as stocks/bond/funds traded by the user on the trading service 90, and/or specified clients of theirs/the financial institution. For example, user profile 84 has access to internal financial institution data and related personalized insights. In particular, the content analysis service 89 has access to the trader's past trades, including on a per customer basis. That can be a major personalization point. The past trade can include intraday trades and/or trades done on previous days. It is recognized that the past trade data can be weighted differently, as desired. The user interest data 86 can be used by the content analysis service 89 to determine a trader's interest (e.g. determining interests based on past articles they've read). Another source of user interest data 86 on traders' interests can be provided to the system 100 by manually requesting traders fill out forms and thus added to the user profile 84.

Example embodiments of the user profile 84 include establishing user interest data 86, which can be obtained by the content analysis service 89 via conducted interviews and/or forms or questionnaires. For example, the user interests 86 can be stored in plaintext and any other format as desired. Further, advantageously using natural language the user interest data 86 can be as specific to any topic or as broad as desired. Examples of the user interest data 86 can include past reading material accessed from the network based content, stock tickers, specific events such as earnings reports, and/or identified market sectors. Once you have this personalized trading data 85,86, the content analysis service 89 can generate a watch list (e.g. News articles, Stock symbols) as content search parameters for use in employing the keyword search and/or embeddings model searching of the network based content 80. For example, the watch list can be compared against aggregated trading data (e.g. data from other traders using the trading platform 90) to evaluate importance of entries on the watch list.

In general, the content analysis service 89 (as implemented by the operation of the server(s) 108) can monitor the network based content 80 using a monitoring service based on a number of criteria from the user profile 84, including for example network usage (e.g. social media)/occurrence of selected one or more keywords (keyword searching for stock tickers) present in network messaging produced by the social media platform(s)/websites 103 (e.g. Facebook™, Twitter™, etc.), as well as the occurrence of those keywords in other network sources such as but not limited to news articles 81, market events 82, and/or research reports 83 available on the communications network 102.

Alternatively, the content analysis service 89 can employ an embeddings model 95 (e.g. implemented using a Huggingface Instructor-XL model) to search the available network based content 80. Potential embeddings models 95 are the OpenAI embeddings model and the Meta Instructor embeddings model. For example, the existing user profile 84 data can be fed to the embeddings model 95 which facilitates the content analysis service 89 to search the network based content 80 on meaning instead of just keywords. For example, the embedding model 95 can be given an embedding instruction, such as “Represent the news article to retrieve insights about a company's stock” in order to optimize information retrieval for finance related insights. The embeddings model is an example of the LLM (Large Language Model).

For example, LLMs can be referred to as a large language model (LLM), in effect a type of artificial intelligence (AI) program (e.g. set of instructions programmed for implementation on oen or more computer processors) that can recognize and generate text, among other tasks. LLMs are trained on large sets of data, and thus are LLMs are built on machine learning: for example a type of neural network called a transformer model. In other words, an LLM is a computer program that has been fed enough examples to be able to recognize and interpret human language or other types of complex data. Many LLMs are trained on data that has been gathered from the network based content 80. LLMs can use a type of machine learning called deep learning in order to understand how characters, words, and sentences function together. Deep learning involves the probabilistic analysis of unstructured data, which eventually enables the deep learning model to recognize distinctions between pieces of content without human intervention. LLMs can then be further trained via tuning: they are fine-tuned or prompt-tuned to the particular task that the programmer wants them to do, such as interpreting questions and generating responses, or translating text from one language to another. Images are another form of example network based content 80 that can be accessed by the LLM, either before or after training, as desired.

In any event, the searching of the available network based content 80 can be used to look through the existing network based content 80 in order to generate a selected number of best representative pieces of content information (e.g. 10 articles or pieces of information) as matching the data 85,86 contained in the user profile 84 (used as a set of content search parameters). For example, one of the sources of the network based content 80 can be an external news API to get actual news articles. For example, one of the sources of the network based content 80 can be provided by performing ad hoc API calls based on market activity. For example, one method of sifting through the sources of the network based content 80 can to filter based on information source specified/type.

Once the search results have been obtained by the keyword/embeddings model by performing the searching of the network based content 80 using the set of search parameters, the search results are passed to the LLM in order to determine of any of the search results are currently relevant (e.g. using the content filters). In this manner, the search results are parsed/filtered semantically, in order to facilitate the identification/derivation of non-obvious insights. As further described below, the application of the LLM to the search results obtained from the search of the network-based content 80 can be implemented using Chain of Thought (CoT) techniques in order to promote the discovery of non-obvious chain of events and insights. Using CoT can facilitate the LLM to discover/filter underlying trends in the search results that can be leveraged by the large amounts of data involved.

Chain-of-Thought techniques such as COT prompting is a prompt technique through which the LLM is guided to output a sequence of intermediate steps that lead to the desired answer. CoT techniques are advantageous in that they increase the efficiency of the computations performed by the LLM as well as improves the reasoning abilities of the LLM. CoT techniques are beneficial because they allow the LLM to focus on solving one step at a time, rather than having to consider the entire problem all at once. CoT techniques can be especially helpful for complex problems that would be difficult or impossible to solve in a single step. CoT techniques provide an interpretable window into the behavior of the LLM. One can see how the LLM arrived at its answer by following the sequence of steps (e.g. chain of events) that the LLM took when employing CoT techniques. In this manner, the use of CoT techniques by the present system can provide the advantage of decreased computational overhead in coming to a more desired output (e.g. discover/filter underlying trends in the search results). For example, CoT techniques can be utilized with the LLM for improving computational performance of the computer system used to implement the LLM.

In employing the LLM, the content analysis service 89 can facilitate the derivation of insights (e.g. personalized information 91) from the search results (e.g. retrieved matching data results including any incoming news and/or optionally users requests) using the prompting via the CoT techniques. For example, the first prompt can ask the LLM to analyze all of the given matching search result data, pull out what may be relevant, and then hypothesize a chain of events using the CoT techniques (i.e. those techniques as is known in the art). It is recognized that only once the LLM has performed the hypotheses, does the LLM make a verdict on whether there exists a relevant insight in the filtered search results that could be provided to the user by way of an insight notification 91 (e.g. personalized insight). It was determined by the authors that prompting the LLM in this style encouraged the discovery of underlying trends and stories that may not have been initially obvious when otherwise just simply observing the filtered data. For example, the LLM utilized for the relevancy checks can be ChatGPT.

Traditional CoT techniques focus on the language modality used, which means that the COT techniques only use text to provide the LLM with a context for reasoning. Multimodal CoT techniques can incorporate text and vision into a two-stage framework. The first step can involve rationale generation based on multimodal information. This means that the LLM can be provided with both text and images, and the LLM is then asked to generate a rationale that explains how the text and images are related. The second phase of the framework can be referred to as answer inference. This is where the LLM uses the informative rationale that it generated in the first step to infer the correct answer to the question. Applications of CoT techniques can be in various reasoning domains, including arithmetic, commonsense, symbolic reasoning, natural language inference, and question answering.

In a further embodiment, a conversational assistant mode can be employed, such that the conversational assistant can is also be implemented using the LLM. Basically, the LLM gets fed all the news articles that are pulled via the API (e.g. the matching search results obtained from the keyword/embeddings model), and thus the LLM is able to intelligently answer questions (e.g. user requests/queries) based on those news articles. In one embodiment, the LLM can interface with LangChain (open source-Google it)., so that if the LLM doesn't know the answer, the LLM can automatically search Google (e.g. the network based content publically available on the communications network 102). In terms of data intake for the user profile 80, one embodiment is manual and based on past trades, as noted above. However, in an alternative embodiment the content analysis service 89 could also use the LLM to obtain trader info as well.

It is recognized that the insight notifications 91 can be sent out when real-time search results (and LLM analysis) is made available by the content analysis service 89. In other words, the content analysis service 8 can be used to generate insight notifications 91, as desired, based on the content of the user profile 84.

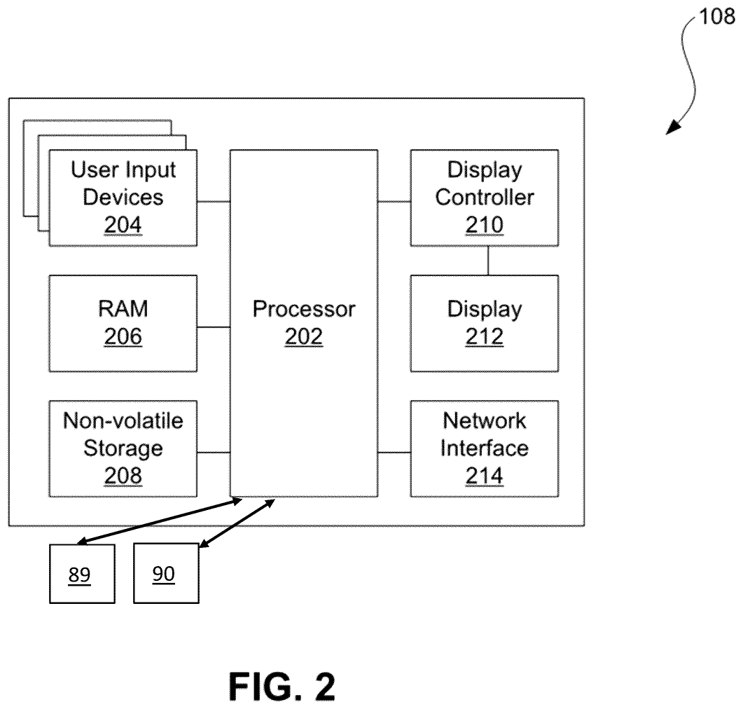

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code (e.g. service 89, 90, user interface 212 such as a dashboard embodied with the service 89, 90) for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 102 and the other servers 108 in the data center 106.

The non-volatile storage 208 has stored on it computer program code that is loaded into the RAM 206 at runtime and that is executable by the processor 202. When the computer program code is executed by the processor 202, the processor 202 causes the server 108 to implement a method for implementing the service 89, 90, such as is described in more detail below. Additionally or alternatively, the servers 108 may collectively perform that method using distributed computing. While the system depicted in FIG. 2 is described specifically in respect of one of the servers 108, analogous versions of the system may also be used for the user devices 104.

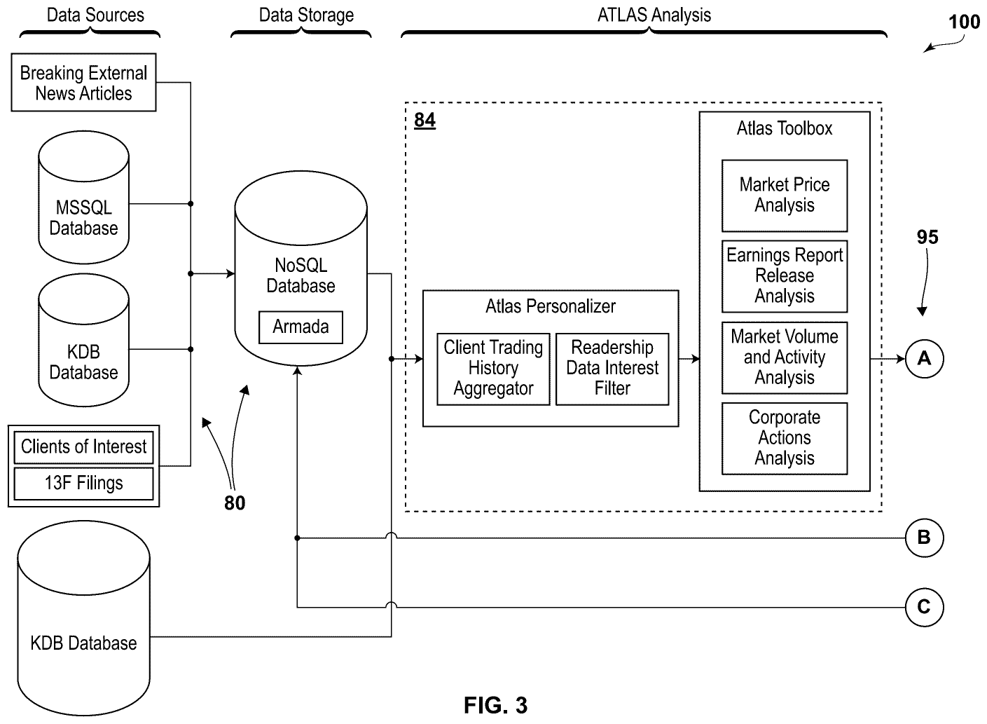

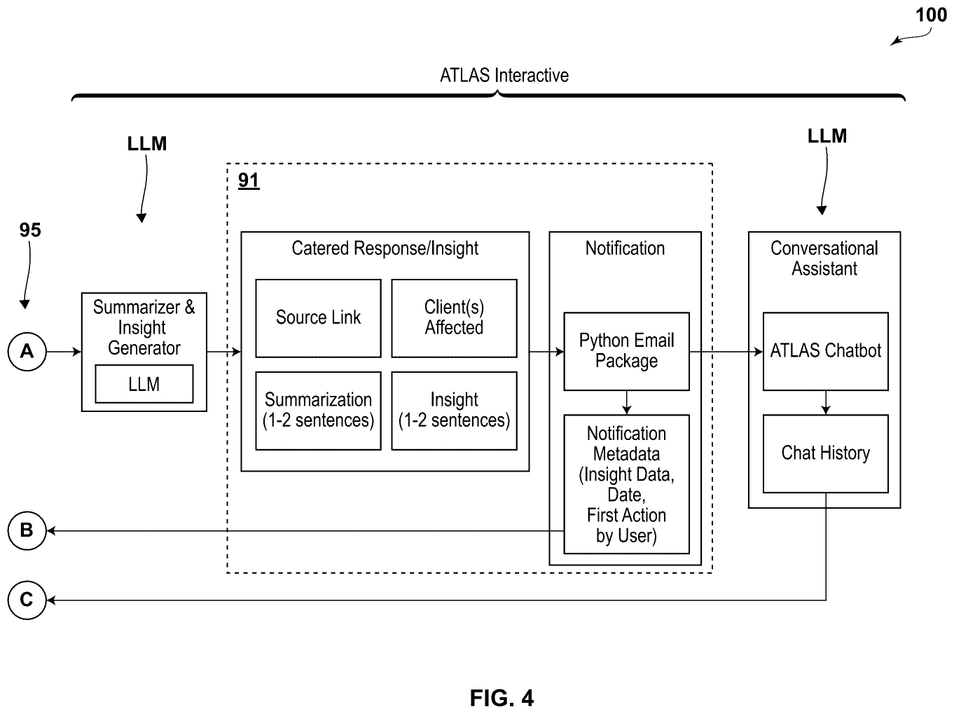

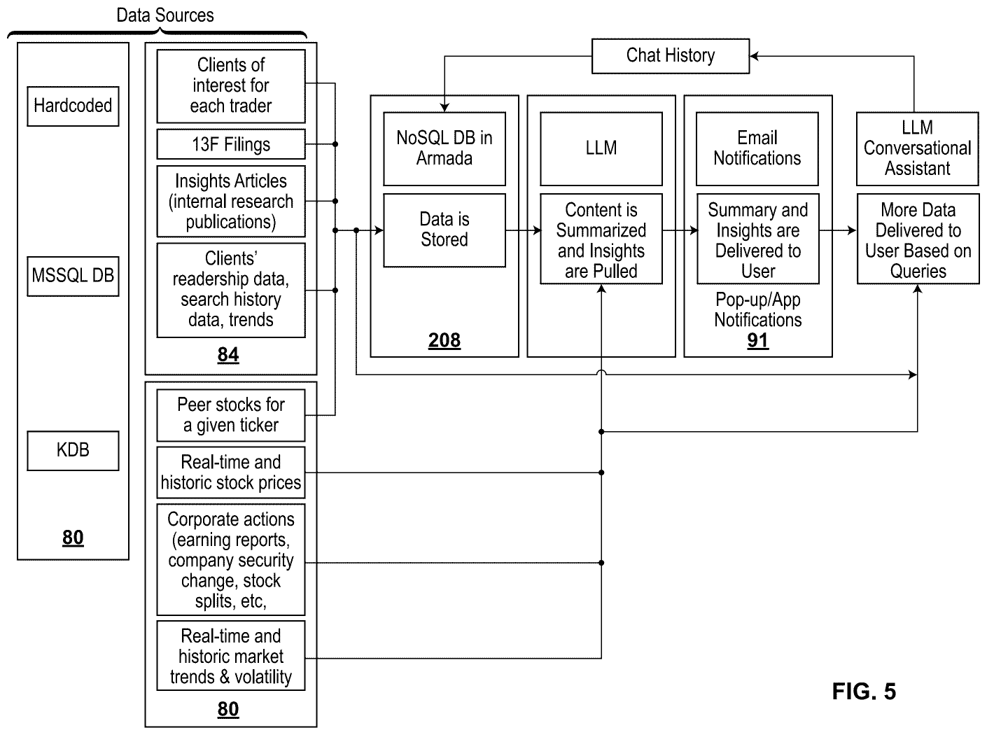

Referring to FIGS. 3 and 4, shown is one embodiment of the computer network system 100, in particular the connected relationships between the LLM and a generated personalized analysis 91, based on the user profiles 84 and network based content 80. FIG. 5 shows an example workflow of the system 100 shown in FIGS. 1, 3,4, including an optional chat function as discussed above.

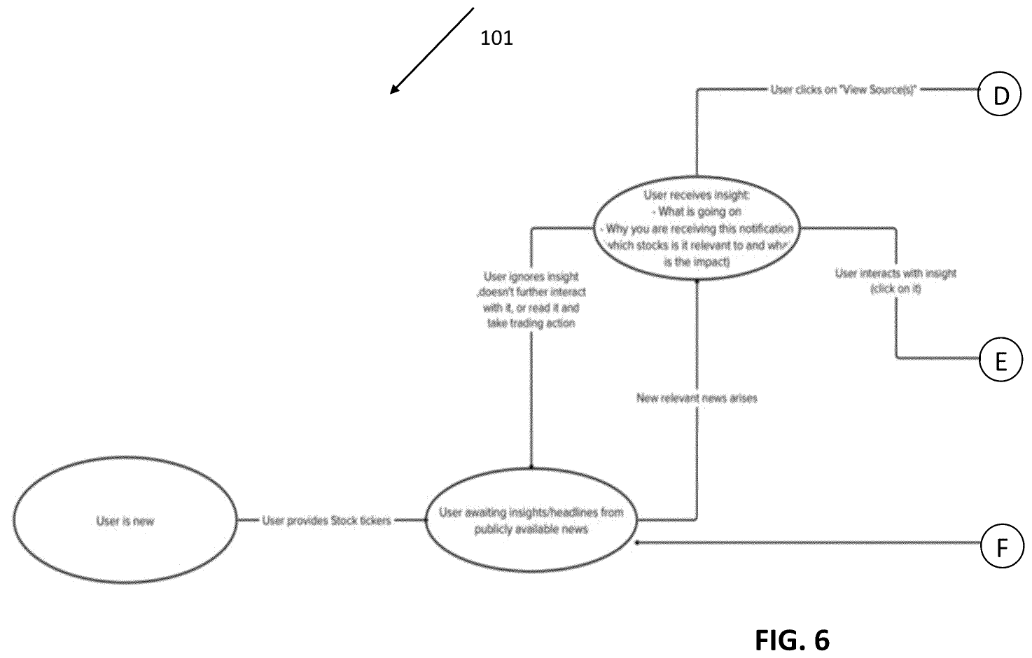

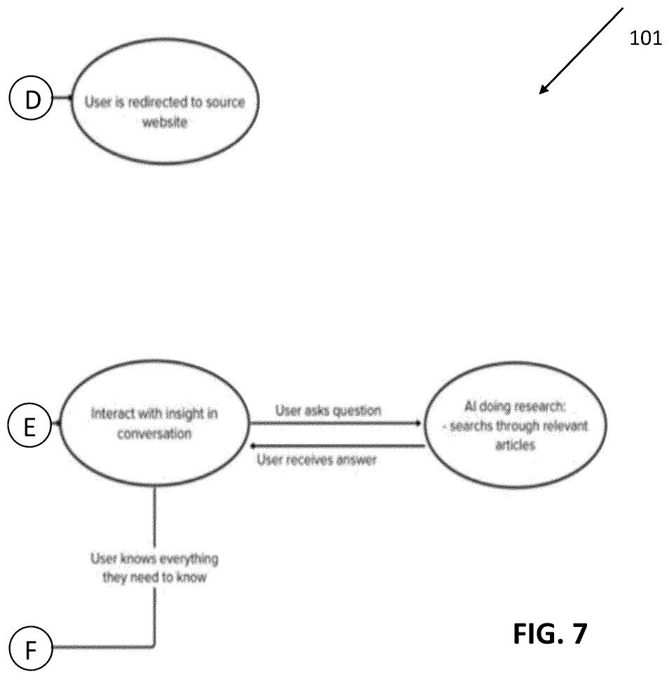

FIGS. 6 and 7 give an example workflow 101 example of operation of the computer network system 100, specifically including operation of the content analysis service 89 in interaction with a user.

Further to the above, it is recognised that described is a system and method for generating the personalized analysis 91 for a user of network based content 80 obtained from a plurality of network sources using a user profile 84 of the user in conjunction with a large language model (LLM), the network sources available over a communications network 102. The method can comprise the steps of: assembling the user profile 84 to contain user profile data including financial instrument information 85 and user interest data 86 associated with the user, the financial information pertaining to a set of financial instruments (e.g. stocks); storing the user profile data 85 in a storage 208 for use as a set of content search parameters and storing user interest data 86 in the storage 208 for use as a set of content filters; comparing the content search parameters to the network based content 80 obtained from a set of network sources to determine matching content (e.g. using keywords, embedding model 95, etc.), the set of network sources selected from the plurality of network sources; providing the matching content and one or more content filters from the set of content filters to an LLM in order to derive a chain of thought based output relevant to the matching content and the one or more content filters; requesting the LLM to determine one or more insights using the chain of thought based output in order to generate the personalized analysis; and generating an insight notification 91 to include the personalized analysis including the one or more insights; and sending the insight notification over the communications network 102 to the user for subsequent processing.

The set of network sources can include content selected from the group consisting of news articles; market events; and topical research associated with the set of financial instruments. The set of financial instruments can include instruments selected from the group consisting of: stocks; bonds; mutual funds; exchange-traded funds; and real estate investment trusts. The financial instrument information can include a history of instrument trading performed by the user including the identified keywords. The identified keywords can include stock symbols representing one or more of financial instruments.in the set of financial instruments. The user interest data can include user selected content obtained from the plurality of network sources. The user selected content can include research reports generated by other members of the financial institution, such that the user is also a member of the financial institution. The content search parameters can be augmented by one or more parameters selected from the group consisting of: a period of time for use in limiting a temporal search window of the network based content; a specified collection of financial instruments from the set of financial instruments; and a specified type of network based content selected from one or more types of available network based content. The embedding model can be a numerical representation of the content search parameters including information selected from the group consisting of: text data; documents; image data; and audio data. The insight notification 91 can be generated synchronously or asynchronously.

As shown in FIGS. 6,7, the method can further comprise receiving a user query in response to the insight notification 91 and employing the LLM to generate a query response (e.g. chat history) associated with the personalized analysis 91, the query response including further insight in addition to the one or more insights.

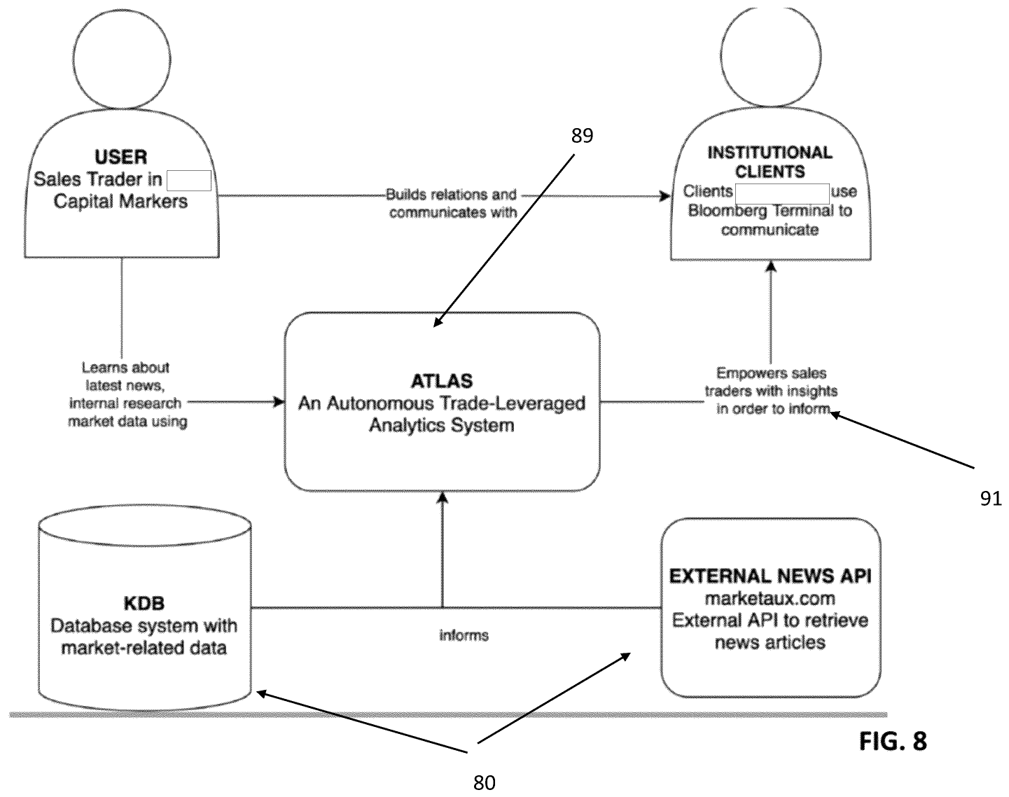

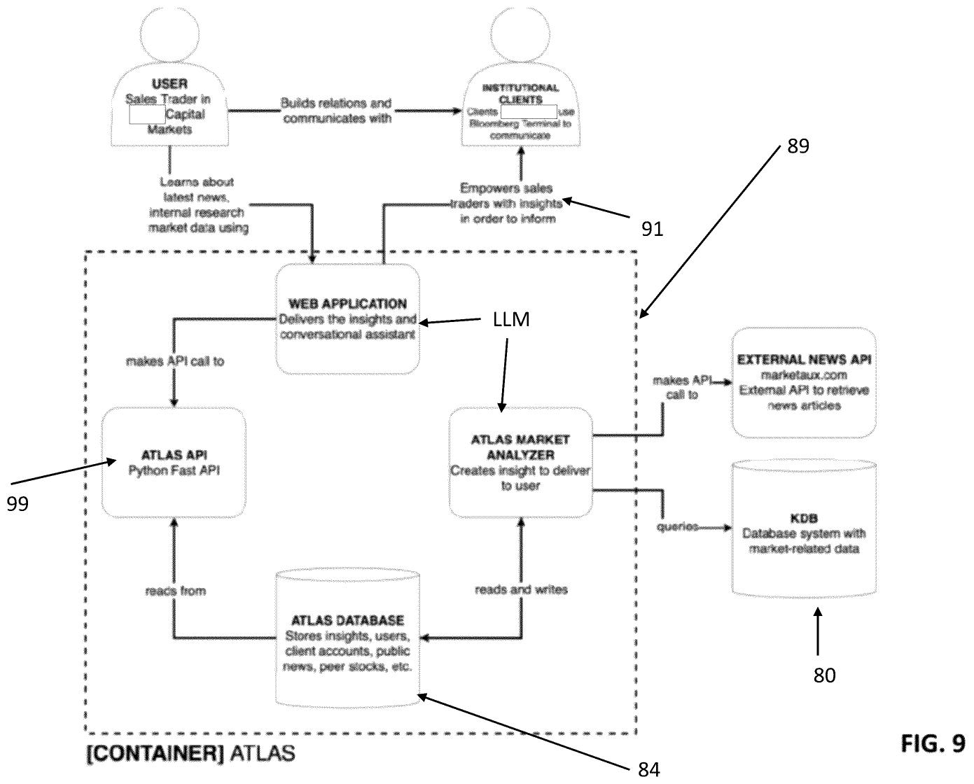

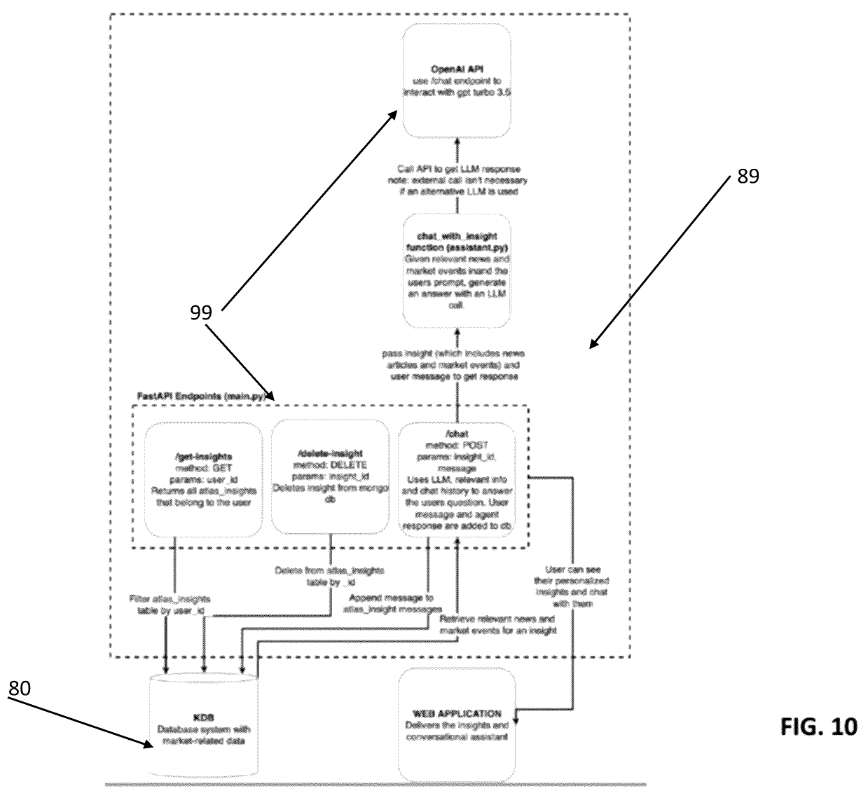

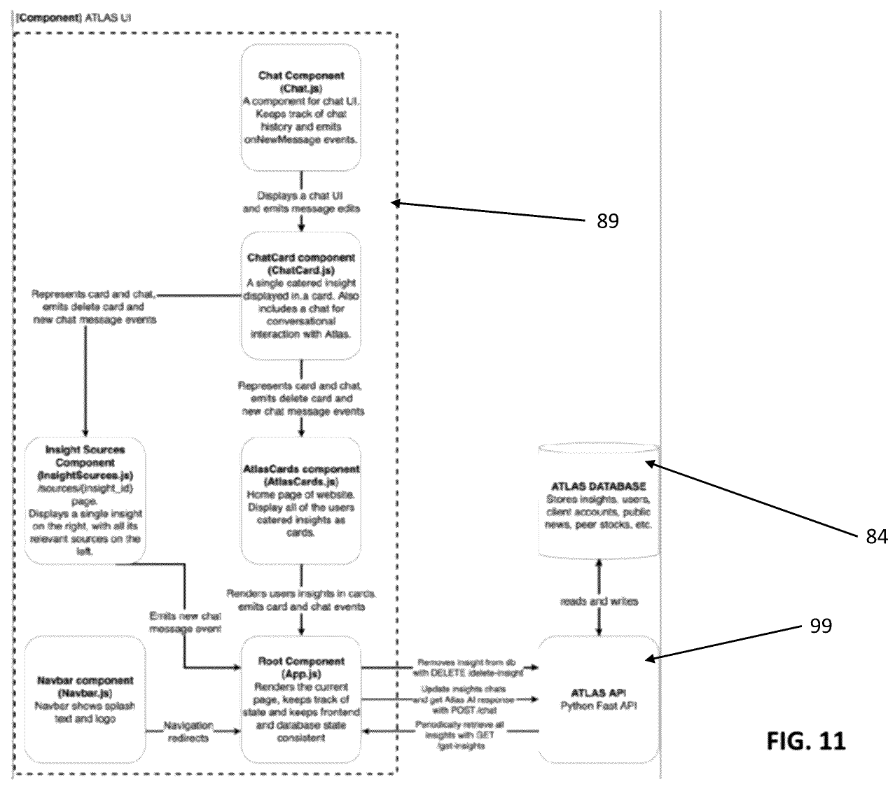

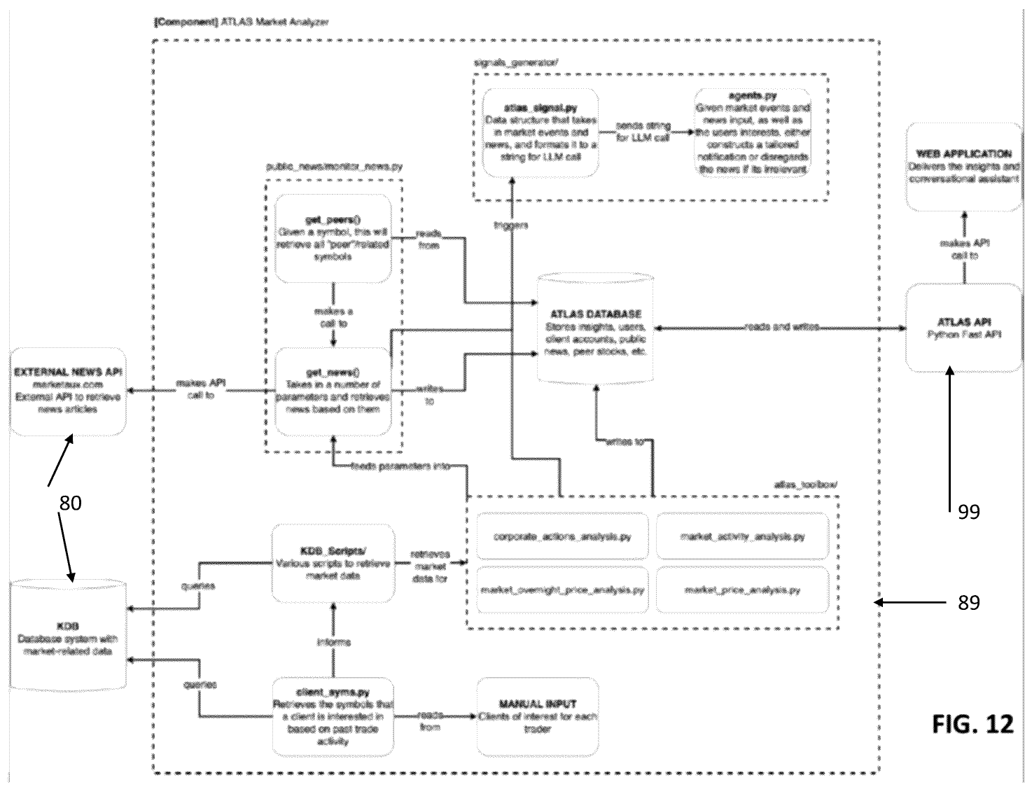

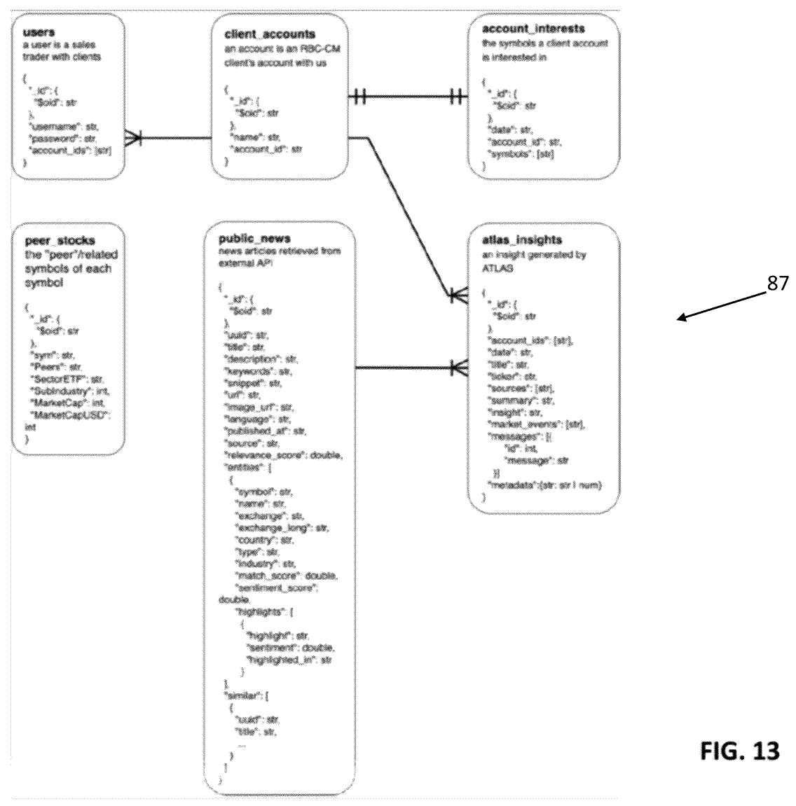

FIG. 8 provides a further example of the interaction the content analysis service 89 for generating insight notifications (e.g. personalized analysis 91) using generative AI (e.g. LLM) to provide client facing sales-traders (e.g. users/members of a financial institution) with personalized and real-time analysis of the impact of available network based content 80. FIG. 9 provides further detail of the content analysis service 89 of FIG. 8, including relevant APIs 99 utilized to implement the LLMs as shown by example. FIG. 10 provides further example detail of the APIs 99 of FIG. 9. FIG. 11 provides further example operational detail of the content analysis service 89 of FIG. 9. FIG. 12 provides further example operational logic of the content analysis service 89 of FIG. 9. FIG. 13 provides example formatting used by the content analysis service 89 of FIG. 9.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

In view of the above, use of the computer network system 100 by the user(s) provides for: desired summaries (including personalized analysis 91) of news 81, market events 82 and/or research reports 83; providing analyses and summaries of the potential impacts on the users recently traded stocks (e.g. financial portfolio) by the information contained in the news, market events and/or research reports; determines the relevancy of an event(s) present in the news, market events and/or research reports to each of the client-facing sales-traders' trades; and creates and sends insight notifications 91 to the user in order to facilitate easy-to-read and quick-to-understand insights contained in the vast expanse of the network based content 80 obtained from the plurality of network sources 80, based on the user profile data 84. Further, the insight notification 91 can be embodied as a message (e.g. email) using summary and impact information of the network based content 80. As discussed above, the conversational assistant can facilitate users to interact with the LLM in order to chat about the data contained in the insight notification 91 and possibly get more/refined information about the content (e.g. quert market data, query recent/related news, research, market events, etc.) . . . . The insight notification 91 can be embodied as a pop-up notification. The content analysis service can be provide as a standalone application or as an add-on to an already existing service (e.g. as a Bloomberg bot). Further, as discussed, dynamic personalization of the insight notifications 91 can be facilitated via the content of the user profile 84, e.g. based on trade history in the past specified amount of time (e.g. one day, one week, etc.).

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification. The scope of the claims should not be limited by the embodiments set forth in the above examples, but should be given the broadest interpretation consistent with the description as a whole. It should be recognized that features and aspects of the various examples provided above can be combined into further examples that also fall within the scope of the present disclosure. In addition, the figures are not to scale and may have size and shape exaggerated for illustrative purposes.

1. A method for generating a personalized analysis for a user of network based content obtained from a plurality of network sources using a user profile of the user in conjunction with a large language model (LLM), the network sources available over a communications network, the method comprising the steps of:
assembling the user profile to contain user profile data including financial instrument information and user interest data associated with the user, the financial information pertaining to a set of financial instruments;
storing the user profile data in a storage for use as a set of content search parameters and storing user interest data in the storage for use as a set of content filters;
comparing the content search parameters to the network based content obtained from a set of network sources to determine matching content, the set of network sources selected from the plurality of network sources;
providing the matching content and one or more content filters from the set of content filters to an LLM in order to derive a chain of thought based output relevant to the matching content and the one or more content filters;
requesting the LLM to determine one or more insights using the chain of thought based output in order to generate the personalized analysis; and
generating an insight notification to include the personalized analysis including the one or more insights; and
sending the insight notification over the communications network to the user for subsequent processing.

2. The method of claim 1, wherein the set of network sources includes content selected from the group consisting of news articles; market events; and topical research associated with the set of financial instruments.

3. The method of claim 1, wherein the set of financial instruments includes instruments selected from the group consisting of: stocks; bonds; mutual funds; exchange-traded funds; and real estate investment trusts.

4. The method of claim 1, wherein the financial instrument information includes a history of instrument trading performed by the user including identified keywords.

5. The method of claim 4, wherein the identified keywords include stock symbols representing one or more of financial instruments.in the set of financial instruments.

6. The method of claim 1, wherein the user interest data includes user selected content obtained from the plurality of network sources.

7. The method of claim 6, wherein the user selected content includes research reports generated by other members of a financial institution, such that the user is also a member of the financial institution.

8. The method of claim 1, wherein the content search parameters are augmented by one or more parameters selected from the group consisting of: a period of time for use in limiting a temporal search window of the network based content; a specified collection of financial instruments from the set of financial instruments; and a specified type of network based content selected from one or more types of available network based content.

9. The method of claim 1 further comprising receiving a user query in response to the insight notification and employing the LLM to generate a query response associated with the personalized analysis, the query response including further insight in addition to the one or more insights.

10. The method of claim 1, wherein the content search parameters including identified keywords are used in said comparing step.

11. The method of claim 1 further comprising generating an embedding from the content search parameters such that the embedding is used in said comparing step.

12. The method of claim 11, wherein the embedding is a numerical representation of the content search parameters including information selected from the group consisting of: text data; documents; image data; and audio data.

13. The method of claim 1, wherein the insight notification is generated synchronously or asynchronously.

14. A computer system for generating a personalized analysis for a user of network based content obtained from a plurality of network sources using a user profile of the user in conjunction with a large language model (LLM), the network sources available over a communications network, the system comprising:
a set of instructions stored on a computer readable medium for causing one or more computer processors to:
assemble the user profile to contain user profile data including financial instrument information and user interest data associated with the user, the financial information pertaining to a set of financial instruments;
store the user profile data in a storage for use as a set of content search parameters and storing user interest data in the storage for use as a set of content filters;
compare the content search parameters to the network based content obtained from a set of network sources to determine matching content, the set of network sources selected from the plurality of network sources;
provide the matching content and one or more content filters from the set of content filters to an LLM in order to derive a chain of thought based output relevant to the matching content and the one or more content filters;
request the LLM to determine one or more insights using the chain of thought based output in order to generate the personalized analysis; and
generating an insight notification to include the personalized analysis including the one or more insights; and
send the insight notification over the communications network to the user for subsequent processing.

15. The computer system of claim 14, wherein the content search parameters are augmented by one or more parameters selected from the group consisting of: a period of time for use in limiting a temporal search window of the network based content; a specified collection of financial instruments from the set of financial instruments; and a specified type of network based content selected from one or more types of available network based content.

16. The computer system of claim 14 further comprising receiving a user query in response to the insight notification and employing the LLM to generate a query response associated with the personalized analysis, the query response including further insight in addition to the one or more insights.

17. The computer system of claim 14, wherein the content search parameters including identified keywords are used in said comparing step.

18. The computer system of claim 14 further comprising generating an embedding from the content search parameters such that the embedding is used in said comparing step.

19. The computer system of claim 14, wherein the embedding is a numerical representation of the content search parameters including information selected from the group consisting of: text data; documents; image data; and audio data.

20. A computer readable media having stored instructions thereon for execution by a computer processor for generating a personalized analysis for a user of network based content obtained from a plurality of network sources using a user profile of the user in conjunction with a large language model (LLM), the network sources available over a communications network, the computer processor executing the stored instructions to:
assemble the user profile to contain user profile data including financial instrument information and user interest data associated with the user, the financial information pertaining to a set of financial instruments;
store the user profile data in a storage for use as a set of content search parameters and storing user interest data in the storage for use as a set of content filters;
compare the content search parameters to the network based content obtained from a set of network sources to determine matching content, the set of network sources selected from the plurality of network sources;
provide the matching content and one or more content filters from the set of content filters to an LLM in order to derive a chain of thought based output relevant to the matching content and the one or more content filters;
request the LLM to determine one or more insights using the chain of thought based output in order to generate the personalized analysis; and
generating an insight notification to include the personalized analysis including the one or more insights; and
send the insight notification over the communications network to the user for subsequent processing.
